(19) United States
(12) Patent Application Publication
(10) Pub. No.: US 2008/0088934 A1
(43) Pub. Date: Apr. 17, 2008

(54) BRIGHTNESS ENHANCEMENT FILM

(75) Inventor: Ju-Hsin Chiang, Taoyuan County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: SPEED TECH CORP., Taoyuan Hsien (TW)

(21) Appl. No.: 11/559,906

(22) Filed: Nov. 15, 2006

(30) Foreign Application Priority Data
Oct. 12, 2006 (TW) 95137511

(51) Int. Cl. G02B 27/00

(52) U.S. Cl. 359/613; 359/831

(57) ABSTRACT

A brightness enhancement film including a substrate and a brightness enhancement structure disposed on the substrate is provided. A surface of the brightness enhancement structure has a plurality of first grooves along a first direction and a plurality of second grooves along a second direction perpendicular to the first direction, so as to define a plurality of pyramid-shaped prism units. A part of the first grooves have a first groove depth, and a part of the second grooves have a second groove depth which is not equal to the first groove depth.

### BACKGROUND OF THE INVENTION

1. Field of Invention

The present invention relates to a brightness enhancement film, and more particularly to a brightness enhancement film for a backlight module.

2. Description of Related Art

The rapid development of multimedia society relies much on the progress of semiconductor devices or man-machine display apparatuses. Among the displays, cathode ray tube (CRT) has occupied the display market for many years, due to its high display quality and low price. However, under the prediction of the environment for an individual operating multiple terminals/display devices, the rising awareness of “environmental protection”, or the trends of saving energy, the cathode ray tube (CRT) having the disadvantages of high power consumption and the limited flattening capability is against the market demands of light, thin, small, chic, and power-saving displays. Therefore, the liquid crystal display (LCD), having superior properties such as high image quality, good space utilization, low power consumption, and no radiation, has become the mainstream display product in the market. As the liquid crystal molecule cannot emit light, a backlight module is required for providing a surface light source for the liquid crystal panel, such that the liquid crystal panel can achieve the display effect and also maintain a sufficient luminance and contrast. FIG. 1 is a schematic sectional view of a conventional side-type backlight module. FIG. 2 is a schematic three-dimensional view of the two brightness enhancement films in FIG. 1. Referring to FIG. 1, the conventional side-type backlight module 100 comprises a light guide plate 110, a cold cathode fluorescent lamp 120, a reflector 130, an optical module 140, and a reflecting plate 150. The light guide plate 110 is usually a tapered light guide plate which has a light entrance plane 112, a light diffusion plane 114, and a light exit plane 116. The cold cathode fluorescent lamp 120 is disposed beside the light entrance plane 112 of the light guide plate 110, and is placed in the reflector 130. The reflecting plate 150 is disposed on the light diffusion plane 114 of the light guide plate 110, and the optical module 140 is disposed on the light exit plane 116.

Referring to FIG. 2, the optical module 140 mainly comprises a diffuser film 142 and two brightness enhancement films 144, 146. The direction of the light passing through the diffuser film 142 is substantially parallel to Z-axis. The brightness enhancement film 144 has a plurality of V-shaped grooves 144a parallel to one another and arranged along the X-direction to concentrate the light in the Y-Z plane direction, and the other brightness enhancement film 146 also has a plurality of V-shaped grooves 146a parallel to one another and along the Y-direction to concentrate the light in the X-Z plane direction.

However, the backlight module 100 further requires for two brightness enhancement films 144, 146 having grooves perpendicular to one another and the diffuser film 142, so as to achieve the purpose of concentrating the light in the Y-Z plane direction and the X-Z plane direction. Thus, the thickness of the entire backlight module, the number of elements in the backlight module, and the manufacturing cost are increased.

### SUMMARY OF THE INVENTION

The present invention is directed to providing a brightness enhancement film, which is a single sheet of brightness enhancement film integrating two conventional brightness enhancement films having grooves perpendicular to one another, so that the number of elements in the backlight module and the thickness of the backlight module are reduced and the manufacturing cost thereof is also reduced. Moreover, brightness enhancement particles used in the brightness enhancement structure also have a light diffusion effect, and thus the brightness enhancement film also has a diffusion effect.

In order to achieve the above or other objectives, the present invention provides a brightness enhancement film, which comprises a substrate and a brightness enhancement structure disposed on the substrate. A surface of the brightness enhancement structure has a plurality of first grooves along a first direction and a plurality of second grooves along a second direction perpendicular to the first direction, so as to define a plurality of prism units of pyramid. A part of the first grooves have a first groove depth, and a part of the second grooves have a second groove depth which is not equal to the first groove depth.

In one embodiment of the present invention, a part of the first grooves have the second groove depth. Further, the first grooves having the second groove depth and the first grooves having the first groove depth are alternatively arranged.

In one embodiment of the present invention, a part of the second grooves have the first groove depth. Further, the second grooves having the first groove depth and the second grooves having the second groove depth are alternatively arranged.

In one embodiment of the present invention, the first direction is substantially perpendicular to the second direction.

In one embodiment of the present invention, the first groove depth is larger than the second groove depth, and less than three times the second groove depth.

In one embodiment of the present invention, the material of the substrate comprises polyethylene terephthalate (PET), polycarbonate (PC), or polymethyl methacrylate (PMMA).

In one embodiment of the present invention, the above brightness enhancement structure is constituted by a high molecular polymer and a plurality of brightness enhancement particles distributed in the high molecular polymer.

In one embodiment of the present invention, the diameter of each brightness enhancement particle is less than 80 μm.

In one embodiment of the present invention, the above brightness enhancement particles are composed of one or more metal materials, one or more nonmetal materials, or a mixture thereof.

In one embodiment of the present invention, the metal material is selected from a group consisting of Ge, Sn, Pb, Al, Si Zn Cu Ag, gold, Ni, Pd, Pt, Co, rhodium, Fe, Ru, Mn, Cr, Mo, Ti, Zr, Sr, Ba, and an alloy thereof, or any combination thereof.

In one embodiment of the present invention, the nonmetal material is selected from a group consisting of B, C, N, O, P, S, and an oxide thereof, or any combination thereof.

In one embodiment of the present invention, the first groove and the second groove are all V-shaped grooves.

In view of the above, in the brightness enhancement structure of the brightness enhancement film of the present invention, a surface of the brightness enhancement film has a plurality of first grooves along a first direction and a plurality of second grooves along a second direction perpendicular to the first direction, so as to define a plurality of prism units of pyramid. As such, the light concentrating effect of the two laminated brightness enhancement films in the conventional backlight module is achieved, and thus the number of devices in the backlight module and the thickness of the backlight module are reduced, and the manufacturing cost thereof is also reduced. Moreover, as the brightness enhancement particles in the brightness enhancement structure also have a light diffusion effect, the brightness enhancement film also has a diffusion effect.

In order to make the aforementioned and other objectives, features and advantages of the present invention comprehensible, preferred embodiments accompanied with figures are described in detail below.

### BRIEF DESCRIPTION OF THE DRAWINGS

FIG. 1 is a schematic sectional view of a conventional side-type backlight module.

FIG. 2 is a schematic isometric view of two brightness enhancement films in FIG. 1.

FIG. 3A is a schematic isometric view of a brightness enhancement film according to one embodiment of the present invention.

FIG. 3B is a schematic side view of the brightness enhancement film taken along the X-axis direction in FIG. 3A.

FIG. 3C is a schematic side view of the brightness enhancement film taken along the Y-axis direction in FIG. 3A.

FIGS. 4-8 are schematic isometric views of a brightness enhancement films according to other embodiments of the present invention respectively.

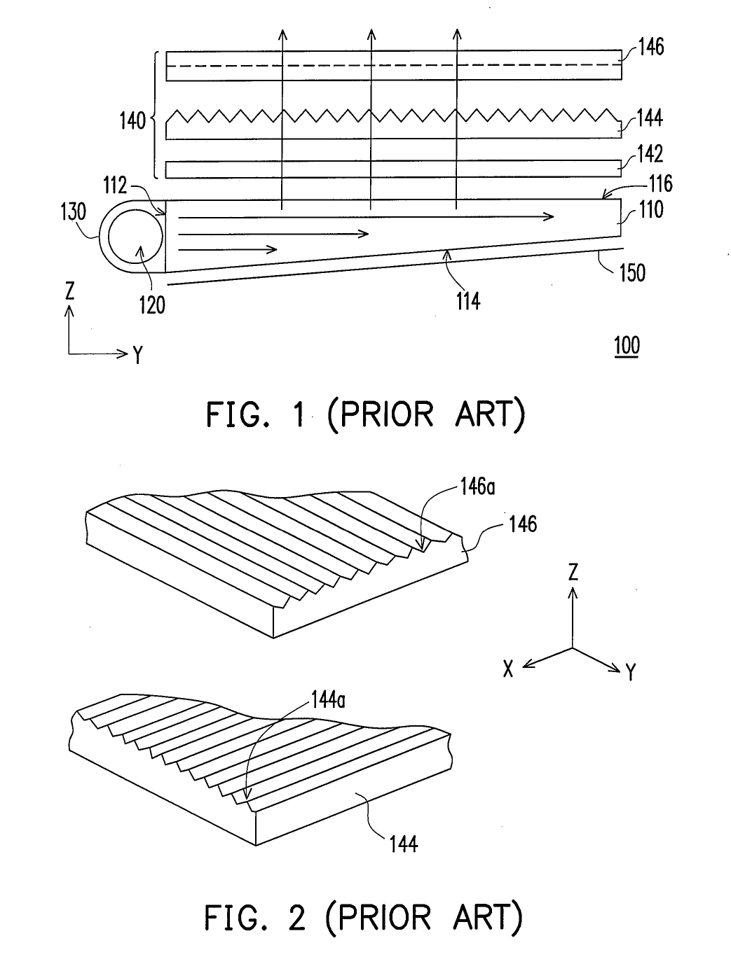

### DESCRIPTION OF EMBODIMENTS

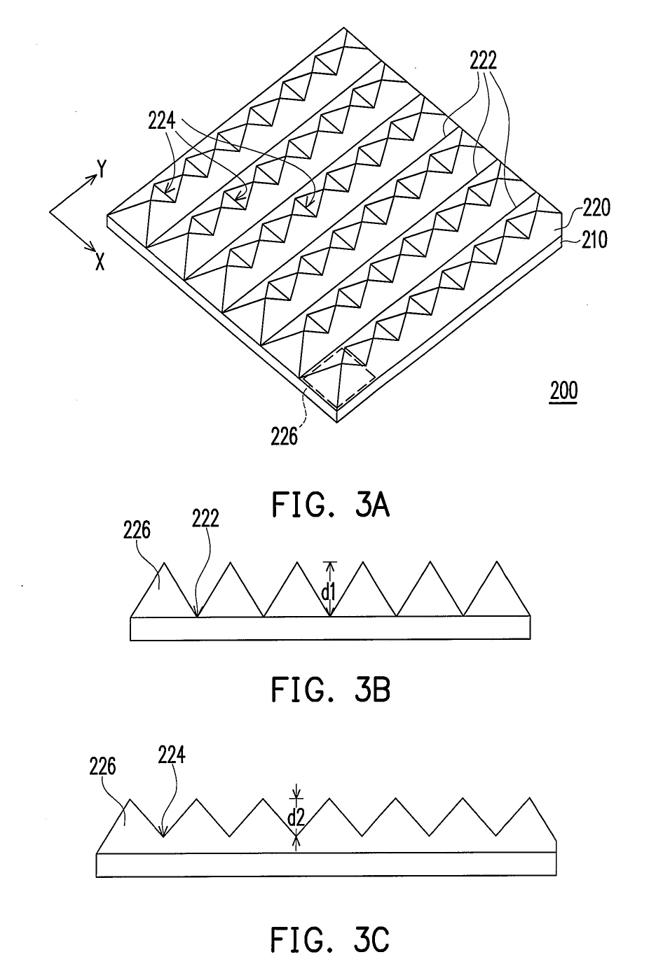

FIG. 3A is a schematic isometric view of a brightness enhancement film according to one embodiment of the present invention. FIG. 3B is a schematic side view of the brightness enhancement film taken along the X-axis direction in FIG. 3A. FIG. 3C is a schematic side view of the brightness enhancement film taken along the Y-axis direction in FIG. 3A. Referring to FIGS. 3A, 3B, and 3C together, the brightness enhancement film 200 mainly includes a substrate 210 and a brightness enhancement structure 220 disposed on the substrate 210. A surface of the brightness enhancement structure 220 has a plurality of first grooves 222 along a first direction (Y-axis) and a plurality of second grooves 224 along a second direction (X-axis) perpendicular to the first direction (Y-axis), so as to define a plurality of prism units 226 arranged in an array. In this embodiment, the first groove 222 and the second groove 224 are V-shaped grooves, and thus each prism unit 226 presents a pyramid shape. Light when passing through the substrate 210 is refracted by the prism units 226, thus achieving a light concentrating effect. In this embodiment, each prism unit 226 is substantially a pyramid-shaped structure.

It can be known from FIGS. 3B and 3C that in the brightness enhancement structure 220, the first groove 222 has a first groove depth d1, and the second groove 224 has a second groove depth d2 which is not equal to the first groove depth d1. In this embodiment, the first groove depth d1 is larger than the second groove depth d2. Moreover, the relation between the first groove depth d1 and the second groove depth d2 meet the following formula:

Second groove depth d2<First groove depth d1<3*Second groove depth d2,

so that the formed prism unit 226 has a preferred light concentrating effect.

The material of the substrate 210 and the brightness enhancement structure 220 will be further illustrated hereinafter. The material of the above substrate comprises polyethylene terephthalate (PET), polycarbonate (PC), or polymethyl methacrylate (PMMA). The brightness enhancement structure 220 disposed on the substrate 210 is composed of a high molecular polymer and a plurality of brightness enhancement particles distributed in the high molecular polymer. In one embodiment of the present invention, the high molecular polymer is epoxy resin, and the brightness enhancement particles are composed of one or more metal materials, one or more nonmetal materials, or a mixture thereof. Further, the above metal material is selected from a group consisting of Ge, Sn, Pb, Al, Si, Zn, Cu, Ag, Au, Ni, Pd, Pt, Co, Rh, Fe, Ru, Mn, Cr, Mo, Ti, Zr, Sr, Ba, and an alloy thereof, or any combination thereof. The nonmetal material is the one selected from a group consisting of B, C, N, O, P, S, and an oxide thereof, or any combination thereof. Moreover, the diameter of the brightness enhancement particles is preferably less than 80 μm, so as to achieve a preferable brightness enhancement effect. The brightness enhancement particles in the brightness enhancement structure 220 not only provide the brightness enhancement effect, but also have a light diffusion effect. The user can adjust the component of the brightness enhancement particles in the brightness enhancement structure 220 according to different using requirements to achieve the brightness enhancement and light diffusion effects for the brightness enhancement film 200.

The brightness enhancement film 200 is fabricated by the follow steps. First, a substrate 210 is provided. Then, a UV curing glue mixed with the brightness enhancement particles is coated on a mold, so that the mold has a geometric shape of the brightness enhancement structure 220 and is adhered onto the surface of the above substrate. Finally, the UV curing glue is irradiated by a UV light and cured. Thus, the fabricating of the brightness enhancement film 200 is complete. Definitely, the brightness enhancement film 200 can also be fabricated in another manner, and the fabricating method is not limited herein.

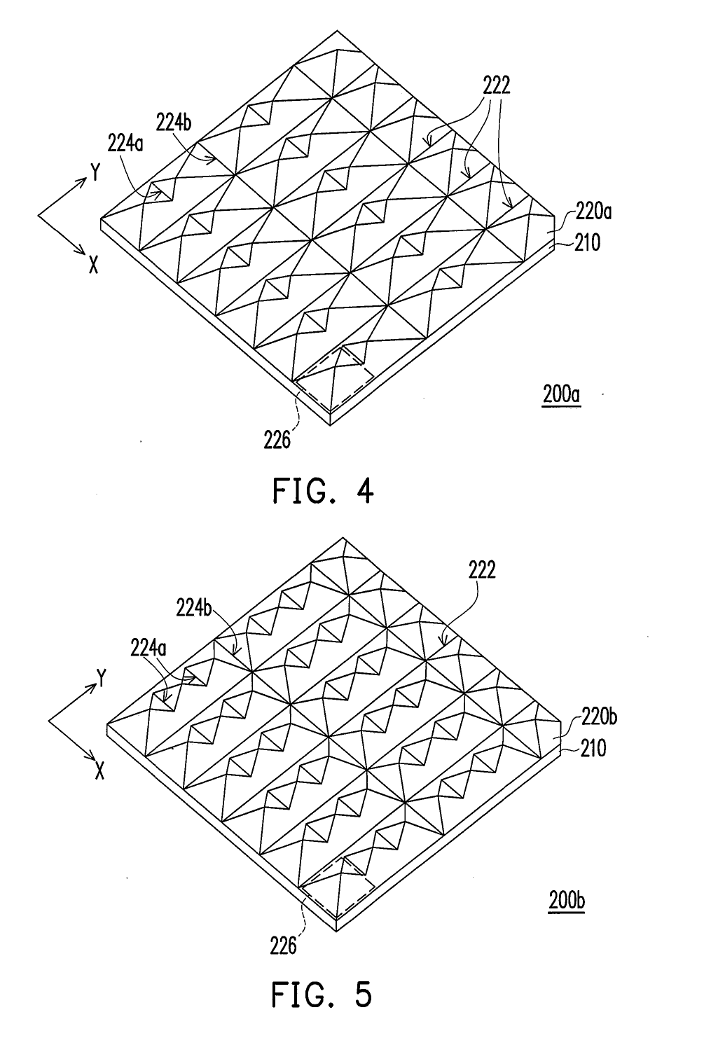

FIGS. 4-8 are schematic isometric views of a brightness enhancement films according to other embodiments of the present invention respectively. First, referring to FIG. 4, the structure of the brightness enhancement film 200a is substantially the same as that of the brightness enhancement film 200 as shown in FIG. 3A, except that the surface of the brightness enhancement structure 200a also has a plurality of first grooves 222 along the Y-axis direction and a plurality of second grooves 224a, 224b along the X-axis direction. The depth of the first groove 222 is also the first groove depth d1, and the depth of a part of the second grooves 224a is also the second groove depth d2, but the depth of the other part of the second grooves 224b is the first groove depth d1. The second groove 224a having the second groove depth d2 and the second groove 224b having the first groove depth d1 are alternatively arranged.

Referring to FIG. 5, the structure of the brightness enhancement film 200b is substantially the same as that of the brightness enhancement film 200a as shown in FIG. 4, except that in the brightness enhancement structure 220b, two second grooves 224a having the second groove depth d2 are disposed in two neighboring second grooves 224b having the first groove depth d1.

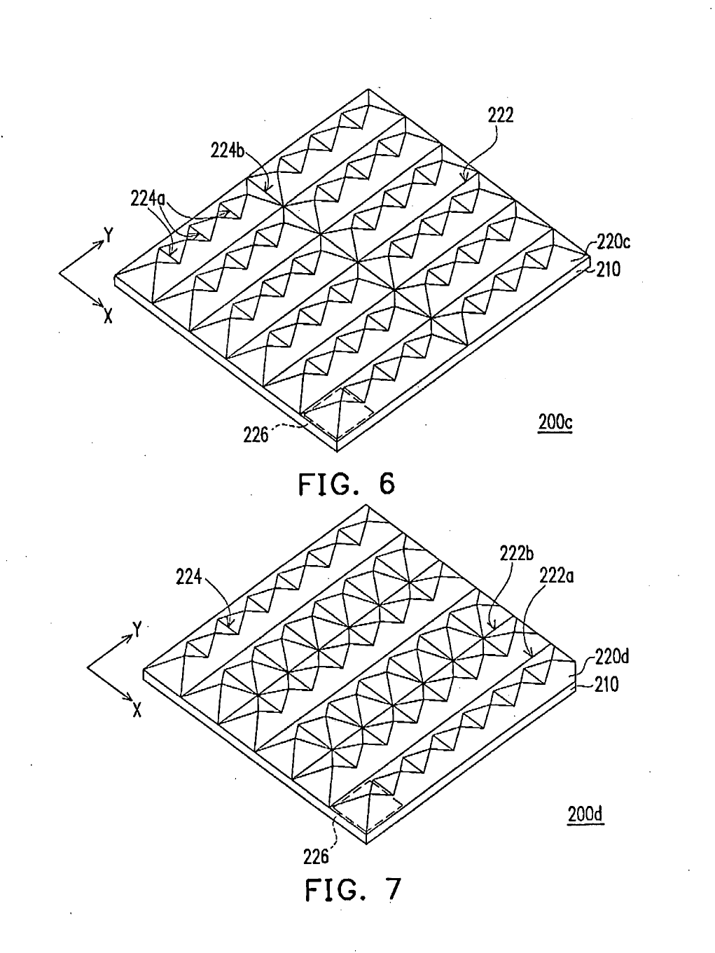

The structure of the brightness enhancement film 200c in FIG. 6 is substantially the same as that of the brightness enhancement film 200a as shown in FIG. 4, except that in the brightness enhancement structure 220c in FIG. 6, three second grooves 224a having the second groove depth d2 are disposed in two neighboring second grooves 224b having the first groove depth d1.

Referring to FIG. 7, the structure of the brightness enhancement film 200d is substantially the same as that of the brightness enhancement film 200 as shown in FIG. 3A, except that the surface of the brightness enhancement structure 220d has a plurality of first grooves 222a, 222b along the Y-axis direction and a plurality of second grooves 224 along the X-axis direction. The depth of a part of the first grooves 222a is also the first groove depth d1, but the depth of the other part of the first grooves 222b is the second groove depth d2. Moreover, the first groove 222a having the first groove depth d1 and the first groove 222b having the second groove depth d2 are alternatively arranged.

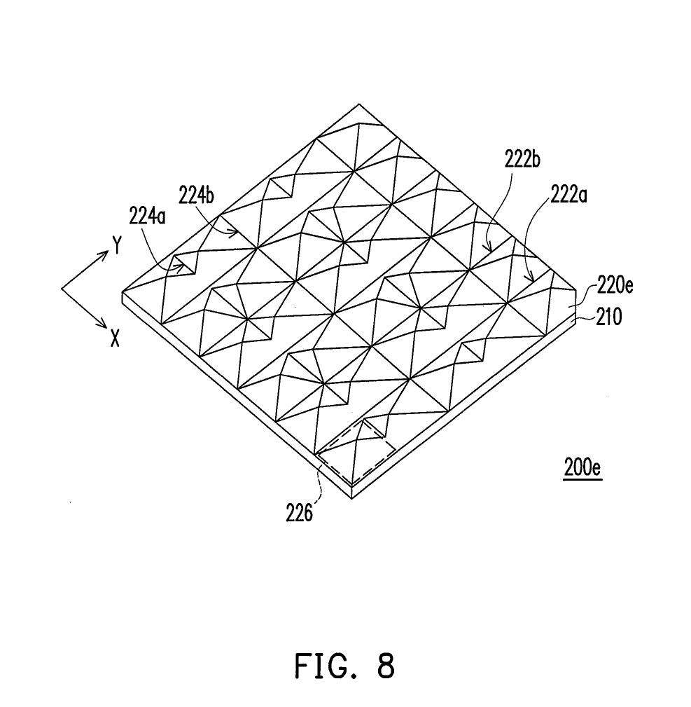

The structure of the brightness enhancement film 200e is substantially the same as that of the brightness enhancement film 200d as shown in FIG. 7, but in the brightness enhancement structure 220e in FIG. 8, the brightness enhancement structure 220e also has a plurality of second grooves 224a, 224b along the X-axis direction in addition to a plurality of first grooves 222a, 222b along the Y-axis direction. The depth of a part of the second grooves 224a is also the second groove depth d2, but the depth of the other part of the second grooves 224b is the first groove depth d1. The second groove 224a having the second groove depth d2 and the second groove 224b having the first groove depth d1 are alternatively arranged, so as to constitute the structure of the brightness enhancement film 200e as shown in FIG. 8.

In the conventional backlight module, each brightness enhancement film only has V-shaped grooves along a single direction (X-axis direction or Y-axis direction). Therefore, it is required to laminate two brightness enhancement films and make the grooves perpendicular to one another to achieve concentrating the light along the Y-Z plane direction and the X-Z plane direction. However, the brightness enhancement film of the present invention has a plurality of first grooves along a first direction and a plurality of second grooves along a second direction perpendicular to the first direction, so that the light concentrating effect of the two brightness enhancement films after being laminated in the conventional backlight module is achieved, thus reducing the number of devices in the backlight module and the thickness of the backlight module and also reducing the manufacturing cost. Moreover, the brightness enhancement particles in the brightness enhancement structure also have a light diffusion effect, and thus the emitted light becomes more uniform and the brightness enhancement effect can be improved.

Though the present invention has been disclosed above by the preferred embodiments, they are not intended to limit the present invention. Anybody skilled in the art can make some modifications and variations without departing from the spirit and scope of the present invention. Therefore, the protecting range of the present invention falls in the appended claims and their equivalents.

1. A brightness enhancement film, comprising;
a substrate; and
a brightness enhancement structure disposed on a surface of the substrate, wherein a surface of the brightness enhancement structure has a plurality of first grooves along a first direction and a plurality of second grooves along a second direction perpendicular to the first direction, so as to define a plurality of pyramid-shaped prism units, wherein a part of the first grooves have a first groove depth, and a part of the second grooves have a second groove depth which is not equal to the first groove depth.

2. The brightness enhancement film as claimed in claim 1, wherein a part of the first grooves have the second groove depth.

3. The brightness enhancement film as claimed in claim 2, wherein the first grooves having the second groove depth and the first grooves having the first groove depth are alternately arranged.

4. The brightness enhancement film as claimed in claim 1, wherein a part of the second grooves have the first groove depth.

5. The brightness enhancement film as claimed in claim 4, wherein the second grooves having the first groove depth and the second grooves having the second groove depth are alternately arranged.

6. The brightness enhancement film as claimed in claim 1, wherein the first direction is substantially perpendicular to the second direction.

7. The brightness enhancement film as claimed in claim 1, wherein the first groove depth is larger than the second groove depth and less than three times the second groove depth.

8. The brightness enhancement film as claimed in claim 1, wherein the material of the substrate comprises polyethylene terephthalate (PET), polycarbonate (PC), or polymethyl methacrylate (PMMA).

9. The brightness enhancement film as claimed in claim 1, wherein the brightness enhancement structure is composed of a high molecular polymer and a plurality of brightness enhancement particles distributed in the high molecular polymer.

10. The brightness enhancement film as claimed in claim 9, wherein the diameter of each brightness enhancement particle is less than 80 μm.

11. The brightness enhancement film as claimed in claim 10, wherein the brightness enhancement particles are composed of one or more metal materials, one or more nonmetal materials, or a mixture thereof.

12. The brightness enhancement film as claimed in claim 11, wherein the metal material is selected from a group consisting of Ge, Sn, Pb, Al, Si, Zn, Cu, Ag, Au, Ni, Pd, Pt, Co, Rh, Fe, Ru, Mn, Cr, Mo, Ti, Zr, Sr, Ba, and an alloy thereof or any combination thereof.

13. The brightness enhancement film as claimed in claim 11, wherein the nonmetal material is selected from a group consisting of B, C, N, O, P, S, and an oxide thereof or any combination thereof.

14. The brightness enhancement film as claimed in claim 1, wherein the first grooves and the second grooves are V-shaped grooves.
